(19) United States
(12) Patent Application Publication
(10) Pub. No.: US 2007/0197744 A1
(43) Pub. Date: Aug. 23, 2007

(54) Method for the production of polymer foams based on reactive polycondensation resins

(75) Inventors: Volker Schadler, Strasbourg (FR); Daniel Schmidt, Savannah, GA (US); Axel Weiss, Speyer (DE)

Correspondence Address: CONNOLLY BOVE LODGE & HUTZ, LLP, P O BOX 2207, WILMINGTON, DE, 19899, US

(73) Assignee: BASF AKTIENGESELLSCHAFT PATENTS, TRADEMARKS AND LICENSES, LUDWIGSHAFEN (DE)

(21) Appl. No.: 10/593,419

(22) PCT Filed: Mar. 17, 2005
(86) PCT No.: PCT/EP05/02845

§ 371 Date: Sep. 19, 2006

(30) Foreign Application Priority Data
Mar. 22, 2004 (DE) 10 2004 014 287.4

(51) Int. Cl. C08F 2/00

(52) U.S. Cl. 526/88

(57) ABSTRACT

Process for producing polymer foams derived from reactive polycondensation resins and having a maximum pore diameter of 1 μm, which comprises: 1) preparing a gelable mixture of the reactive polycondensation resin in a solvent or dispersion medium, 2) preparing an aqueous dispersion comprising polymer particles, 3) mixing the mixture from step 1) with the dispersion from step 2) to give a water-containing gel, and 4) drying the water-containing gel to give the polymer foam, with drying in step 4) being carried out at a pressure and a temperature which are below the critical pressure and below the critical temperature of the liquid phase of the gel and the gel not being brought into contact with an organic liquid to replace the water present in the gel by this liquid after step 3) and before step 4).

The invention relates to a process for producing polymer foams which are based on reactive polycondensation resins and have a number average pore diameter of not more than 1 μm by gel formation, which comprises the following steps:
1) preparing a gelable mixture of the reactive polycondensation resin in a solvent or dispersion medium,
2) preparing an aqueous dispersion comprising polymer particles,
3) mixing the mixture of the reactive polycondensation resin from step 1) with the dispersion comprising polymer particles from step 2) to give a water-containing gel, and
4) drying the water-containing gel to give the polymer foam,
   with drying in step 4) being carried out at a pressure and a temperature which are below the critical pressure and below the critical temperature of the liquid phase of the gel and
   the gel not being brought into contact with an organic liquid to replace the water present in the gel by this liquid after step 3) and before step 4).

Furthermore, the invention relates to the polymer foams obtainable by the process. A foam is a material which, for the purposes of the present invention, is not obtained by foaming but in another way. For the present purposes, the term “foam” refers to porous material and does not mean “obtainable by foaming”. In particular, a polymer foam is a structure made up of gas-filled, spherical or polyhedral cells which are bounded by semiliquid, highly viscous or solid cell struts. The cell struts, which are bound via triple points, form a coherent framework. The cell struts are spanned by the foam lamella (in the case of a closed-celled foam). If the foam lamella are destroyed or flow back into the cell struts at the end of foam formation, an open-celled foam is obtained.

Nanoporous polymer foams (foams) having a pore size of significantly below 1 μm and a total porosity of over 70% are, due to theoretical considerations, particularly good thermal insulators.

Polymer foams comprising polycondensation resins such as melamine-formaldehyde resins or other crosslinked polymers can, for example, be produced by a sol-gel process. Here, a sol is firstly prepared from the polycondensation resin and the sol is then gelled by means of condensation reactions to form a gel. To obtain a foam from the gel, the liquid has to be removed. This step will, since the liquid is usually water, hereinafter be referred to as drying in the interests of simplicity.

For the present purposes, a so is a colloidal solution in which the solid or liquid polymer is distributed in very finely divided form in a (usually liquid) dispersion medium, and a gel is a crosslinked system comprising a close-knit polymer which is present in a liquid (known as solvogel or lyogel, with water as liquid: aquagel or hydrogel). The polymer forms a coherent phase in the form of a continuous three-dimensional network.

According to the processes of the prior art, the liquid can be removed from the gel, for example under supercritical conditions or by means of supercritical fluids, i.e. at pressures and temperatures above the critical point p_{crit} or the critical temperature T_{crit} of the liquid. In this way, aerogels (polymer network in a gas) can be produced.

Thus, U.S. Pat. No. 5,128,382 describes the production of microcellular epoxy polymers by preparing a polymer solution, inducing a phase separation and drying or extracting the resulting gels under supercritical conditions.

U.S. Pat. No. 5,402,306 discloses, inter alia, formaldehyde resins from which a crosslinked gel is firstly prepared in a sol-gel process. The liquid water present in the gel is then replaced by acetone by storing the gel in acetone, and the acetone is finally removed by extraction and drying by means of CO₂ under supercritical conditions. This gives an aerogel.

In J. Non-Cryst. Solids 188, 34-40 (1995), Pekala et al. describe a similar process in which a phenol-furfural gel is prepared, the liquid phase of the gel (1-propanol) is replaced by CO₂ and the CO₂ is then removed by supercritical drying.

In Carbon 38, 1499-1524 (2000), Li et al. describe the production of cresol-formaldehyde aerogels by preparation of corresponding water-containing gels, replacement of the water present in the gel by acetone, subsequent replacement of the acetone by CO₂ and supercritical drying.

In J. Vac. Sci. Technol. A, 6 (4), 2559-2563 (1988), Hair et al. describe the production of resorcinol-formaldehyde aerogels by preparation of corresponding aqueous gels, treatment with trifluoroacetic acid, replacement by acetone and subsequent replacement of the acetone by CO₂ and supercritical drying.

Drying under supercritical conditions is very complicated in terms of apparatus, since defined pressure and temperature conditions have to be maintained in closed vessels. In addition, solvents exchangers are necessary. This additionally complicates the process. Drying using supercritical fluids therefore impairs the economics.

As an alternative, the liquid can be removed by freeze drying. However, the volume of the liquid changes on freezing and destroys the three-dimensional polymer network. This process does not give a foam but instead results in a powder.

Drying under nonsupercritical conditions, i.e. at pressures and temperatures below p_{crit} and T_{crit} (hereinafter referred to as subcritical drying), is described in WO 94/22943: a resorcinol-formaldehyde gel is prepared and cut into thin slices. The water present in the gel is then replaced by acetone, and the acetone is subsequently replaced by cyclohexane. Finally, the cyclohexane is allowed to evaporate in air at 20-50° C. However, the porosity of the foam obtained is low.

In Carbon 40, 2955-2959 (2002), Li et al. describe the production of cresol-resorcinol-formaldehyde aerogels from the corresponding water-containing gels, replacement of the water by acetone and drying of the gel at 50° C. and atmospheric pressure.

In J. Non-Cryst. Solids 221, 144-150 (1997), Saliger et al. describe the production of resorcinol-formaldehyde aerogels from the corresponding water-containing gels, replacement of the water by acetone and subcritical drying of the gel at 50° C. Accordingly, in subcritical drying, the water present in the gel firstly has to be replaced in a cumbersome and time-consuming manner by a more volatile, organic solvent. Two different solvents may even be necessary. Only this organic solvogel obtained from the hydrogel can then be dried.

The earlier patent application DE No. 10353745.7, which is not a prior publication (filing date Nov. 17, 2003), describes nanoporous polymer foams which are obtainable by curing of microemulsions composed of an aqueous reactive polycondensation resin, an oil component and an amphiphile. Acids such as phosphoric acids as catalyst and ammonium chloride as accelerator have to be concomitantly used for this purpose.

It is an object of the invention to remedy the abovementioned disadvantages. In particular, a process which makes it possible to produce nanoporous polymer foams having extremely small pores and is notable for its simplicity is to be provided.

The process should allow drying of the polymer gel with low energy consumption and in high space-time yields. In particular, the process should make do without the use of supercritical conditions or supercritical fluids.

In addition, it should not be necessary to replace the water present in the gel by an organic solvent prior to drying.

Polymer foams having a high porosity should be able to be produced particularly advantageously by means of the process.

We have accordingly found the process defined at the outset and the polymer foams obtainable by the process. Preferred embodiments of the invention are defined in the subordinate claims.

In the process of the invention, polymer foams which are based on reactive polycondensation resins (hereinafter also referred to as resins for short) and have a mean pore diameter of not more than 1 μm are produced by gel formation.

In step 1) of the process, a gelable mixture of the reactive polycondensation resin with a solvent or dispersion medium (solvent for short) is prepared. Such a gelable mixture can be, for example, a genuine solution, a sol (colloidal solution) or a dispersion, e.g. an emulsion or suspension.

Examples of suitable reactive polycondensation resins are reactive resins based on formaldehyde or substituted formaldehydes such as furfural. Examples are resins whose first component is selected from among formaldehyde and furfural and whose second component is selected from among urea, benzoguanamine, resorcinol, catechol, hydroquinone, melamine, phloroglucinol, aniline and cresol. The reactive polycondensation resin is preferably water-soluble and is particularly preferably an amino resin. The amino resin can be unmodified or modified, for example etherified with alcohols such as methanol or ethanol.

In particular, a urea-, benzoguanamine- or melamine-formaldehyde resin can be used. Very particular preference is given to using a melamine-formaldehyde resin, for example an alcohol-modified melamine-formaldehyde resin having a melamine/formaldehyde ratio in the range from 1:1 to 1:10, preferably from 1:2 to 1:6.

Such resins are known and are commercially available, for example as Luwipal®063 from BASF.

The choice of solvent naturally depends on the resin used. All solvents which give a gelable mixture, i.e. allow gel formation, are suitable. In the case of the preferred water-soluble resins, water is preferably used as solvent.

The gelable mixture or the sol from step 1) usually contains from 0.5 to 15% by weight, preferably from 1 to 10% by weight and particularly preferably from 2 to 8% by weight, of the reactive polycondensation resin.

The gelable mixture, for example the sol, is prepared in a manner known per se. Depending on the solubility of the resin, the mixture may be obtained simply by combining resin and solvent. For example, the preferred water-soluble melamine-formaldehyde resins can simply be diluted with water at room temperature (23° C.). In the case of a relatively low solubility, mixing apparatuses, for example stirrers, high-speed stirrers, dispersers, e.g. those having a rotor-stator system, or colloid mills, may be necessary. The mixture can, for example, be prepared at room temperature (20° C.) or below this or above this up to 100° C., depending on the solubility of the resin.

In step 2) of the process, an aqueous dispersion comprising the polymer particles is prepared.

Suitable polymer particles are, for example, particles based on styrene monomers (vinylaromatic monomers) such as styrene, α-methylstyrene, p-methylstyrene, ethylstyrene, tert-butylstyrene, vinylstyrene, vinyltoluene, 1,2-diphenylethylene or 1,1-diphenylethylene; particles based on dienes such as 1,3-butadiene (butadiene for short), 1,3-pentadiene, 1,3-hexadiene, 2,3-dimethylbutadiene, isoprene or piperylene; and particles based on alkyl acrylates or methacrylates having from 1 to 12 carbon atoms in the alkyl radical, e.g. methyl acrylate, n- or tert-butyl acrylate or 2-ethylhexyl acrylate, and the corresponding methacrylates, e.g. methyl methacrylate (MMA).

Polymer particles based on acrylic compounds such as acrylic acid, acrylamide, acrylonitrile, methacrylamide; on compounds containing acetate groups, e.g. vinyl acetate; olefins such as ethylene, propylene; and on carboxylic acids such as itaconic acid and fumaric acid are likewise suitable. Copolymers such as ethylene-vinyl acetate copolymers are also suitable. Further monomers which are suitable for the particles are mentioned in DE-A 196 33 626 on page 3, lines 5-50 under M1 to M10, which is hereby expressly incorporated by reference. Polymer particles based on polyurethanes are likewise possible.

The polymer particles can be homopolymers or copolymers, i.e. it is also possible to use polymer particles comprising mixtures of the abovementioned monomers, for example particles of styrene-butadiene copolymer which can, for example, be a random or block copolymer, or of styrene-α-methylstyrene copolymer.

The polymer particles preferably comprise polymers based on monomers selected from among styrene, butadiene, alkyl acrylates and alkyl methacrylates. Particular preference is given to using polystyrene particles. For example, particles comprising a polystyrene which contains acrylamide and acrylic acid as comonomers in amounts of from 0.1 to 5% by weight each, based on the polymer, are very well-suited.

In a preferred embodiment of the process, the polymer particles have a mean diameter of from 20 to 500 nm, in particular from 30 to 400 nm and particularly preferably from 40 to 300 nm.

The proportion of polymer particles in the aqueous dispersion (solids content) in step 2) is usually from 0.5 to 70% by weight, preferably from 5 to 60% by weight and in 10 particular from 10 to 52% by weight.

An aqueous dispersion of polymer particles is also referred to as a polymer latex. Such latices, e.g. polystyrene, styrene-butadiene copolymer, polyacrylate or polyurethane latices, are known and can, for example, be prepared by free-radical polymerization by means of a persulfate initiator, or are commercially available as finished latex under the trade names Acronal®, Styrofan®, Styronal®, Basonal® or Luhydran®, all from BASF. The desired polymer particle content can, if appropriate, be adjusted by addition or removal of water.

In a preferred embodiment, the aqueous dispersion from step 2) contains a surfactant, particularly preferably an ionic or nonionic surfactant.

Ionic surfactants may be cationic surfactants, for example quaternary ammonium compounds having one or two hydrophobic groups and salts of long-chain primary amines, also amphoteric surfactants such as N-(acylamidoalkyl)betaines and amine N-oxides. Particularly useful surfactants are anionic surfactants, e.g. soaps, alkylbenzenesulfonates (ABS), alkylsulfonates, alkyl sulfates and alkyl ether sulfates.

Suitable nonionic surfactants are, for example, fatty alcohol ethoxylates, alkylphenol ethoxylates, sorbitan fatty acid esters, alkyl polyglycosides and N-methylglucamides; also block copolymers comprising ethylene oxide and/or propylene oxide.

Very particular preference is given to using anionic surfactants, for example sodium dodecylsulfate.

The proportion of surfactants in the dispersion in step 2) is generally from 0 to 5% by weight, preferably from 0.3 to 5% by weight, particularly preferably from 0.5 to 3% by weight and in particular from 0.7 to 2% by weight, based on the polymer particles as such, i.e. without the water present in the dispersion.

It is possible to use various polymer particles and surfactants, and in this case the amounts indicated are based on the sum of the particles or surfactants.

The preparation of the aqueous dispersion in step 2) is carried out in a customary fashion, for example by mixing water, polymer particles and surfactants, if appropriate using customary mixing apparatuses such as stirrers, until the polymer particles are uniformly distributed in the aqueous phase. If a finished polymer latex is used, the dispersion can also be added by simply adding the surfactant to the latex if the finished latex does not already contain such a surfactant. The other mixing conditions are not critical; for example, mixing can be carried out at room temperature.

In step 3) of the process, the mixture of the reactive polycondensation resin from step 1) is mixed with the dispersion comprising polymer particles from step 2). This gives a water-containing gel.

The mixing ratio of gelable resin mixture from step 1) and polymer dispersion from step 2) can vary according to the desired properties of the foam and naturally also depends on the water or solvent content of the components.

In step 3), the reactive polycondensation resin and the polymer particles are preferably mixed with one another in a mixing ratio of from 10:1 to 1:10, disregarding water and other solvents or dispersion media. In particular, this mixing ratio is from 5:1 to 1:5, particularly preferably from 3:1 to 1:3.

The mixture comprising the resin and the polymer particles which is obtained in step 3) usually has a total solids content of from 0.5 to 25% by weight, preferably from 1 to 20% by weight and in particular from 5 to 15% by weight.

The mixing in step 3) is carried out in a customary fashion, e.g. by combining the resin mixture from step 1) and the polymer dispersion from step 2). This is preferably done using a stirrer or another customary mixing apparatus in order to achieve good mixing. The other mixing conditions are not critical; for example, mixing can be carried out at from 0 to 100° C. and from 0.1 to 10 bar (absolute), in particular, for example, at room temperature and atmospheric pressure.

The gel is formed from the resulting mixture by allowing it to rest, e.g. by simply leaving the container in which the mixture is present (gelation container) to stand. During gelation (gel formation), the mixture is preferably not stirred or mixed in any other way, because this could hinder formation of the gel. It has been found to be advantageous to cover the mixture during gelation or to close the gelation container.

The duration of gelation varies according to the type and amount of the components used and can be a number of days. It is usually from 1 minute to 10 days, preferably from 1 hour to 5 days, in particular about 4 days. A higher gelation temperature usually shortens the gelation time.

Temperature and pressure during gelation can be, for example, from 0 to 150° C., preferably from 15 to 100° C. and particularly preferably from 15 to 70° C., and from 0.1 to 100 bar (absolute), preferably from 0.5 to 10 bar (absolute) and in particular from 0.9 to 5 bar (absolute). In particular, aqueous mixtures can, for example, be allowed to gel at room temperature and atmospheric pressure.

During gelation, the mixture solidifies to form a more or less dimensionally stable gel. Gel formation can therefore be recognized in a simple way in that the contents of the gelation vessel no longer move when the container is slowly tilted. In addition, the acoustic properties of the mixture alter on gelation: when the outer wall of the container is tapped, the gel mixture gives a different, humming sound compared to the as yet ungelled mixture (known as humming gel).

It is preferred that no inorganic or organic acids such as hydrochloric acid, phosphoric acid, acetic acid, formic acid, p-toluenesulfonic acid, p-dodecylbenzenesulfonic acid or other acids are necessary as catalyst for gelation. It is also preferably not necessary to use salts such as ammonium chloride which accelerate gelation.

In a preferred embodiment, the gel obtained on gelation in step 3) is subjected to aging, during which formation of the gel is completed, prior to step 4). Aging is carried out, for example, by subjecting the gel to a temperature higher than in the preceding gelation for some time. This can be done using, for example, a heating bath or an oven.

In general, aging is carried out at temperatures of from 30 to 150° C., preferably from 40 to 100° C., and the aging temperature should be from about 10 to 130° C., in particular from 20 to 80° C., above the gelation temperature. If gelling has been carried out at room temperature, aging can be carried out at, for example, from 40 to 80° C., preferably about 60° C. The pressure during aging is not critical and is usually from 0.9 to 5 bar (absolute). The duration of aging is usually from 10 minutes to 30 days, preferably from 20 minutes to 20 days and particularly preferably from 30 minutes to 5 days. Depending on type and composition, the gel can shrink slightly during aging and become detached from the wall of the gelation container. The gel is advantageously covered during aging or the container is closed.

According to the invention, the gel is not brought into contact with an organic liquid in order to replace the water present in the gel by this liquid after step 3) and before step 4). This applies regardless of whether the gel is or is not aged.

Organic liquids of this type, which are not necessary here, would be, for example, volatile organic compounds such as ketones such as acetone, alkanes such as cyclohexane, alcohols or ethers having, for example, from 1 to 10 carbon atoms. They are necessary in the processes of the prior art in order to displace the water present in the gel from the voids of the gel. In these known processes, the water-containing gel is stored for a number of hours or days in the organic liquid which may have to be replaced a number of times by fresh liquid.

This replacement of the water present in the gel by acetone or another organic liquid is not necessary according to the invention, i.e. according to the invention, the gel is not treated with acetone, etc. This simplifies the process of the invention and makes it cheaper.

In step 4) of the process of the invention, the water-containing gel is dried. This forms the polymer foam as process product. According to the invention, drying is carried out at a pressure and a temperature which are below the critical pressure and below the critical temperature of the liquid phase of the gel.

The liquid phase of the gel consists essentially of the solvent of the resin mixture from step 1), for example water, and the water of the aqueous polymer dispersion from step 2). Drying means removal of this liquid phase.

To dry the gel, the gelation container is opened and the abovementioned pressure and temperature conditions are maintained until the liquid phase has been removed by transformation into the gaseous state, i.e. the liquid phase is evaporated (vaporized). To accelerate this evaporation, it is advantageous to remove the gel from the container. In this way, the phase interface gel/ambient air via which evaporation takes place is increased. For example, the gel can be placed on a flat substrate or a sieve for drying.

The gel can be dried in air or, if it is oxygen-sensitive, under other gases such as nitrogen or noble gases, and a drying oven or other suitable apparatuses can, if appropriate, be used for this purpose.

The temperature and pressure conditions to be selected during drying depend on the liquid phase. According to the invention, drying is carried out at a pressure which is below the critical pressure p_{crit} of the liquid phase and at a temperature which is below the critical T_{crit} of the liquid phase. Accordingly, drying is carried out under subcritical conditions.

For the present purposes, “critical” has the following meaning: at the critical pressure and the critical temperature, the density of the liquid phase is equal to the density of the gas phase (known as critical density), and at temperatures above T_{crit} the gas can no longer be liquefied even under very high pressures. In the case of the preferred liquid phase water, T_{crit} is 374° C. and p_{crit} is 221.29 bar; in the case of CO ₂, T_{crit} is 31.06° C. and p_{crit} is 73.825 bar (absolute).

The water-containing gel is usually dried at temperatures of from 0 to 150° C., preferably from 10 to 120° C. and particularly preferably from 15 to 100° C., and at pressures ranging from a high vacuum (10⁻⁷ mbar) to 300 bar, preferably from 1 mbar to 10 bar and in particular from 10 mbar to 5 bar (absolute). For example, drying can be carried out at atmospheric pressure and from 0 to 80° C., in particular at room temperature.

The gel is particularly preferably dried in step 4) at a pressure of from 0.5 to 2 bar absolute and at a temperature of from 0 to 100° C.

Drying can be accelerated or completed by application of a vacuum. To improve the drying action further, this vacuum drying can be carried out at a higher temperature than drying at the usual pressure. For example, the major part of the water can firstly be removed at room temperature and atmospheric pressure over a period of, for example, from 8 to 12 days, and the remaining water can then be removed at from 40 to 80° C. under a reduced pressure of, for example, from 1 to 100 mbar, in particular from 10 to 30 mbar, over a period of from 1 to 5 days.

Instead of such stepwise drying, the pressure can also be reduced continuously, for example linearly or exponentially, during drying, or the temperature can be increased in such a way, i.e. along a pressure or temperature program.

Naturally, the gel dries faster, the lower the humidity of the air. The same applies analogously to liquid phases other than water and gases other than air.

During drying in step 4), the liquid phase is generally removed completely or to a residual content of from 0.01 to 1% by weight, based on the polymer foam obtained.

The process of the invention gives a polymer foam having a mean pore diameter of not more than 1 μm. The mean pore diameter is preferably from 10 nm to 1 μm, particularly preferably from 100 nm to 500 nm.

The foam preferably has a porosity of at least 70% by volume, in particular at least 90% by volume, i.e. at least 70% or 90% of the foam volume consists of pores. The porosity can be determined, for example, in a porosimeter by mercury intrusion. Here, mercury is pushed under pressure into a sample of the foam. Small pores require a higher pressure in order to be filled with Hg than do larger pores, and a pore size distribution can be determined from the corresponding pressure/volume curve.

The density of the polymer foam is usually from 20 to 300 g/l, preferably from 30 to 200 g/l and particularly preferably from 40 to 100 g/l.

The process of the invention gives a coherent foam and not merely a polymer powder or polymer particles. The three-dimensional shape of the foam is determined by the shape of the gel which is in turn determined by the shape of the gelation container. Thus, for example, a cylindrical gelation container usually gives an approximately cylindrical gel which is then dried to give a foam having the shape of a cylinder.

The invention therefore also provides the polymer foam obtainable by the process of the invention.

The process found is uncomplicated and produces nanoporous polymer foams having extremely small pores and a very high porosity. Owing to the simple method of drying under subcritical conditions in particular, the process requires less energy and makes high space-time yields possible. It makes do without supercritical conditions or supercritical fluids, and, in addition, organic liquids are not required for replacing the water present in the gel. The process found is therefore simpler in terms of apparatus and can be operated using fewer materials, and is finally cheaper.

### EXAMPLES

As reactive polycondensation resin, use was made of a melamine-formaldehyde resin etherified with methanol as a 70% strength by weight solution in water. The molar ratio of melamine:formaldehyde:methanol was 1:3.6:2.

A polystyrene latex (aqueous dispersion of polystyrene particles, obtained in a conventional way by free-radical polymerization using sodium persulfate as initiator) was used as polymer dispersion. The mean particle diameter was 119 nm, and the 30 polystyrene comprises 97% by weight of styrene, 1.5% by weight of acrylamide and 1.5% by weight of acrylic acid. The latex contains 1% by weight of sodium dodecylsulfate as anionic surfactant, and the solids content of the latex was 48.4% by weight.

### Example 1

2.14 g of the 70% by weight aqueous solution of the melamine-formaldehyde resin were diluted with 25.4 ml of water at 20° C. with stirring. This gave a clear, 5.5% strength by weight solution to which 3.1 g of the polystyrene latex were subsequently added at 20° C. while stirring. The mixture obtained was milky white and had a total solids content of 10% by weight. The weight ratio of melamine-formaldehyde resin to polystyrene particles in the mixture was 1:1, disregarding the water.

The container was closed and gelation was carried out by allowing the mixture to stand without stirring at 20° C. After 4 days, a white gel had formed, which could be seen by, inter alia, the altered, humming sound when the outer wall of the container was tapped.

The gel was subsequently subjected to aging by heating the closed container at 60° C. in a water bath for 12 days. During this time, the gel shrank slightly and became detached from the container wall.

The aged gel was finally transferred from the container to a glass plate and dried, firstly in air at 20° C. at atmospheric pressure for 10 days and then at 60° C. in a drying oven for 3 days until the pressure in the oven was about 20 mbar.

This gave a fine-celled polymer foam. The porosity and the pore size distribution were measured by mercury intrusion. The total porosity was 71% by volume, and the pore size distribution is reported in Table 1.

TABLE 1
Pore size distribution

| Pore size | % by volume |
|---|---|
| 10 to ≦50 nm | 6.66 |
| 50 to ≦100 nm | 30.58 |
| 100 to ≦500 nm | 41.10 |
| 500 to ≦1000 nm | 9.79 |
| 1 to ≦5 μm | 7.66 |
| 5 to ≦10 μm | 1.11 |
| 10 to ≦50 μm | 1.17 |
| 50 to ≦100 μm | 0.46 |
| 100 to ≦300 μm | 1.47 |

Accordingly, 88% by volume of the pores were smaller than or equal to 1 μm. The number average pore diameter was 160 nm.

The example shows that a nanoporous foam having a high porosity could be produced in a simple manner and without conventional foaming by means of the process of the invention.

### Example 2

Example 1 was repeated, but gelation was carried out at 80° C. instead of 20° C. This resulted in the duration of gelling being shortened to 4 hours.

Example 3C for comparison: without polystyrene latex

Example 1 was repeated, but no polystyrene latex was added. No gelation occurred.

Examples 4C to 8C for comparison: using acid and NH₄CI instead of polystyrene latex 4 g of the 70% strength by weight aqueous solution of the melamine-formaldehyde resin were diluted with 11 g of water at 20° C. with stirring. This gave a clear, 20% strength by weight solution to which the amount of ammonium chloride indicated in table 2 was subsequently added and completely dissolved at 20° C. with vigorous stirring. The mixture was then acidified with concentrated hydrochloric acid to a pH of about 4.

The container was closed and gelation was carried out by allowing the mixture to stand without stirring at 20° C. After the time indicated in table 2, a gel (for appearance, see table 2) had formed, which could be seen by, inter alia, the altered sound when the outer wall of the container was tapped.

The aged gel was then transferred from the container to a glass plate and dried, firstly in air at 20° C. at atmospheric pressure for 10 days and then at 60° C. in a drying oven for 3 days until the pressure in the oven was about 20 mbar.

The porosity was calculated by determining the density of the foam and comparing this with the density of the unfoamed melamine-formaldehyde resin. It is reported in table 2.

TABLE 2
comparative examples

| Example | 4C | 5C | 6C | 7C | 8C |
|---|---|---|---|---|---|
| Amount of | 0.14 | 0.28 | 0.42 | 0.56 | 0.70 |
| NH₄Cl [g] | | | | | |
| Gelation | 23 | 20 | 18 | 16 | 14 |
| time [min] | | | | | |
| Appearance | blue | color- | color- | color- | color- |
| of the gel | tinge, | less, | less, | less, | less, |
| | semi- | trans- | opaque | opaque | opaque |
| | trans- | lucent | | | |
| | parent | | | | |
| Porosity | 0 | 0 | 74 | 83 | 83 |
| [% by | | | | | |
| volume] | | | | | |
| Comment | no foam | no foam | macro- | large | large |
| | | | pores | macro- | macro- |
| | | | | pores | pores |

The polymer in comparative examples 4C and 5C had a porosity of 0% by volume, i.e. was not a foam. Although a foam was obtained in comparative examples 6C to 8C, it was macroporous.

1-11. (canceled)

12. A process for producing polymer foams which are based on reactive polycondensation resins and have a number average pore diameter of not more than 1 μm by gel formation comprising:
1) preparing a gelable mixture of the reactive polycondensation resin in a solvent or dispersion medium,
2) preparing an aqueous dispersion comprising polymer particles,
3) mixing the mixture of the reactive polycondensation resin from step 1) with the dispersion comprising polymer particles from step 2) to give a water-containing gel, and
4) drying the water-containing gel to give the polymer foam,
with drying in step 4) being carried out at a pressure and a temperature which are below the critical pressure and below the critical temperature of the liquid phase of the gel and
the gel not being brought into contact with an organic liquid to replace the water present in the gel by this liquid after step 3) and before step 4).

13. The process according to claim 12, wherein the polymer particles have a mean diameter of from 20 to 500 nm.

14. The process according to claim 12, wherein the reactive polycondensation resin is an amino resin.

15. The process according to claim 14, wherein the amino resin is a melamine-formaldehyde resin.

16. The process according to claim 12, wherein the polymer particles comprise polymers based on monomers selected from among styrene, butadiene, alkyl acrylates and alkyl methacrylates.

17. The process according to claim 12, wherein the dispersion from step 2) comprises an ionic or nonionic surfactant.

18. The process according to claim 12, wherein the gel obtained in step 3) is subjected to aging before step 4).

19. The process according to claim 12, wherein the reactive polycondensation resin and the polymer particles are mixed with one another in a mixing ratio of from 10:1 to 1:10, disregarding water and other solvents or dispersion media, in step 3).

20. The process according to claim 12, wherein drying in step 4) is carried out at a pressure of from 0.5 to 2 bar and a temperature of from 0 to 100° C.

21. The process according to claim 12, wherein the polymer foam has a porosity of at least 70% by volume.

22. A polymer foam obtainable by the process according to claim 12.
